(19) United States
(12) Patent Application Publication
(10) Pub. No.: US 2026/0048947 A1
(43) Pub. Date: Feb. 19, 2026

(54) SMART CONVEYOR SYSTEM

(71) Applicants: STEVE GAUGER, CRYSTAL LAKE, IL (US); BRIAN SCHWARTZ, NORTH BARRINGTON, IL (US); ROBERT C. JONELIS, CRYSTAL LAKE, IL (US); CHAD ELLIOTT, NAPERVILLE, IL (US); DAVID ANCHOR, UNION, IL (US)

(72) Inventors: STEVE GAUGER, CRYSTAL LAKE, IL (US); BRIAN SCHWARTZ, NORTH BARRINGTON, IL (US); ROBERT C. JONELIS, CRYSTAL LAKE, IL (US); CHAD ELLIOTT, NAPERVILLE, IL (US); DAVID ANCHOR, UNION, IL (US)

(21) Appl. No.: 18/806,619

(22) Filed: Aug. 15, 2024

(51) Int. Cl. B65G 47/57; A47F 10/06; B65G 41/00; B65G 43/10

(52) U.S. Cl. CPC B65G 47/57; A47F 10/06; B65G 41/001; B65G 43/10; B65G 2201/0202

(57) ABSTRACT

A smart conveyor system for conveying food orders from a restaurant to patrons disposed within vehicles, comprises a first patron drive-through lane, a second patron drive-through lane, a first vertically oriented conveyor tower, a second vertically oriented conveyor tower, a horizontally oriented conveyor housing extending above the first patron drive-through lane and connecting the first and second vertically oriented conveyor towers together, and at least one conveyor traversing the first and second vertically oriented conveyor towers and the horizontally oriented conveyor housing for transferring a food order from the first vertically oriented conveyor tower to the horizontally oriented conveyor housing, and from the horizontally oriented conveyor housing to the second vertically oriented conveyor tower. A sensor activated-computer-controlled system controls the various conveyors.

### FIELD OF THE INVENTION

The present invention relates generally to food service equipment, and more particularly to a smart/computer-controlled conveyor system which is adapted to be particularly useful in connection with the conveying of food service orders to be provided to food service patrons who have placed food orders at drive-through fast-food restaurants.

### BACKGROUND OF THE INVENTION

Many fast-food restaurants have vehicle drive-through lanes whereby patrons, wishing to place food orders, drive up to an intercom located at a first predetermined location of the fast-food establishment, place their food order, and then drive to a food order pickup station located at a second predetermined location of the fast-food establishment so as to retrieve their food order. Some fast-food restaurants even comprise a pair of vehicular drive-through lanes, parallel to each other, whereby patrons can place their food orders simultaneously, with the result that twice as many food orders can be placed, received, and accommodated within a particular period of time. Still further, many fast-food restaurants also feature internet-based pre-ordering systems, thereby increasing the ordering capacity of the restaurant within a predetermined period of time. The problem with these types of systems, however, is that the food order retrieval area of the fast-food establishment only comprises a single location at which all food orders are paid for and retrieved, whereby the dual vehicular traffic lanes must necessarily be merged. This logistical situation, however, obviously causes vehicular bottlenecks, which effectively defeat the original purpose or objective of having or providing multiple food-order traffic lanes.

A need therefore exists for a new and improved conveyor system. Another need exists in the art for a new and improved conveyor system that can be utilized by fast-food restaurants. Still another need exists in the art for a new and improved conveyor system that can be utilized by fast-food restaurants in connection with the processing of food orders placed by patrons. Yet still another need exists in the art for a new and improved conveyor system that can be utilized by fast-food restaurants in connection with the processing of food orders placed by patrons while the patrons are seated within their vehicles located in drive-through lanes. Still yet another need exists in the art for a new and improved conveyor system that can be utilized by fast-food restaurants in connection with the processing of food orders placed by patrons while the patrons are seated within their vehicles located in drive-through lanes, whereby twice as many food orders are able to be placed and processed within a predetermined period of time. A further need exists in the art for a new and improved conveyor system that can be utilized by fast-food restaurants in connection with the processing of food orders placed by patrons while the patrons are seated within their vehicles located in drive-through lanes, whereby twice as many food orders are able to be placed and processed within a predetermined period of time, or alternatively, whereby the wait time, for placing the food order and for receiving the prepared food order, is significantly reduced. A last need exists in the prior art for a new and improved conveyor system that can be utilized by fast-food restaurants in connection with the processing of food orders placed by patrons wherein the safety of restaurant employees could be enhanced, if the traditional drive-through lane was eliminated, by preventing inherent safety risks characteristic of face-to-face interactions within the drive through arena.

### OVERALL OBJECTIVES OF THE INVENTION

An overall objective of the present invention is to provide a new and improved conveyor system. Another overall objective of the present invention is to provide a new and improved conveyor system that can be utilized by fast-food restaurants. Still another overall objective of the present invention is to provide a new and improved conveyor system that can be utilized by fast-food restaurants in connection with the processing of food orders placed by patrons. Yet still another overall objective of the present invention is to provide a new and improved conveyor system that can be utilized by fast-food restaurants in connection with the processing of food orders placed by patrons while the patrons are seated within their vehicles located in drive-through lanes. Still yet another overall objective of the present invention is to provide a new and improved conveyor system that can be utilized by fast-food restaurants in connection with the processing of food orders placed by patrons while the patrons are seated within their vehicles located in drive-through lanes, whereby twice as many food orders are able to be placed and processed within a predetermined period of time. A further overall objective of the present invention is to provide a new and improved conveyor system that can be utilized by fast-food restaurants in connection with the processing of food orders placed by patrons while the patrons are seated within their vehicles located in drive-through lanes, whereby twice as many food orders are able to be placed and processed within a predetermined period of time, or alternatively, whereby the wait time, for placing the food order and for receiving the prepared food order, is significantly reduced. A last overall objective of the present invention is to provide a new and improved conveyor system that can be utilized by fast-food restaurants in connection with the processing of food orders placed by patrons wherein the safety of restaurant employees could be enhanced, if the traditional drive-through lane was eliminated, by preventing inherent safety risks characteristic of face-to-face interactions within the drive through arena.

### SUMMARY OF THE INVENTION

The foregoing and other objectives of the present invention are achieved as a result of a conveyor system that comprises a first vertically oriented conveyor tower disposed internally within the fast-food restaurant edifice, a second vertically oriented conveyor tower spaced apart from the fast-food restaurant edifice and the first vertically oriented conveyor tower and disposed upon an opposite side of a first patron drive-through lane defined and provided adjacent to the fast-food restaurant edifice, and a horizontally oriented conveyor disposed atop, and effectively bridging and connecting, the upper end regions of the first and second vertically oriented conveyor towers together so as to be disposed above the first patron-drive-through lane, the lower end portion of the second vertically oriented conveyor tower being disposed adjacent to a second patron drive-through lane. In this manner, it will be appreciated that a first patron will have placed his food order, and paid for the same, in a conventional manner, that is, upstream of the first vertically oriented conveyor tower, and then drives up to the first vertically oriented conveyor tower, by means of the first drive-through lane, so as to retrieve or receive his/her food order. In a similar manner, a second patron, disposed within a second vehicle located within the second patron drive-through lane, can similarly order and pay for particular food items, however, the second patron, disposed within the second vehicle located within the second patron drive-through lane, does not need to drive to an order pickup station, but to the contrary, the conveyor system will deliver the food order directly to the second patron disposed within the second vehicle located within the second patron drive-through lane. In this manner, it can be readily appreciated that the conveyor system of the present invention is significantly more efficient than current systems in that two patrons disposed within both the first and second lanes of the conveyor system can be simultaneously serviced. Still yet further, a unique bypass control system is effectively incorporated within the conveyor system so as to permit errant orders to be immediately rectified whereby a correct order may be routed to the second patron disposed within a second vehicle located within the second patron drive-through lane. To initiate this corrective mode of operation, the second vertically oriented conveyor tower is provided with an intercom whereby the second patron, disposed within the second patron vehicle located within the second patron drive-through lane, can effectively communicate with restaurant staff to inform them of an errant food order. It is lastly noted that the conventional food ordering and payment system can effectively be bypassed as a result of patrons pre-ordering and paying by means of online mobile food ordering procedures.

### BRIEF DESCRIPTION OF THE DRAWINGS

Various other objects, features and attendant advantages of the present invention will be more fully appreciated from the following detailed description when considered in connection with the accompanying drawings in which like reference characters designate like or corresponding parts throughout the several views, and wherein:

FIG. 1 is a perspective view of the new and improved smart or computer-controlled conveyor system for simultaneously servicing a pair of parallel fast-food restaurant vehicular drive-through traffic lanes, wherein the conveyor system comprises a pair of vertically oriented conveyor towers and a horizontally oriented conveyor disposed atop and effectively bridging and connecting the uppermost regions of the pair of vertically oriented conveyor towers;

FIG. 2 is a perspective view of the lower end portion of the first, restaurant-side vertically oriented conveyor tower showing the user or human-machine interface (HMI), a door or opening which permits restaurant personnel to insert food trays into the first vertically oriented conveyor tower, and a used-tray collection box;

FIG. 3 is a perspective view of a first embodiment of a restaurant-side vertically movable conveyor carriage which is adapted to move vertically within the first vertically oriented conveyor tower of the conveyor system disclosed within FIG. 1;

FIG. 4 is a perspective view of a second embodiment of a restaurant-side vertically movable conveyor carriage which is adapted to move vertically within the first vertically oriented conveyor tower of the conveyor system disclosed within FIG. 1;

FIG. 5 is a perspective view of the lower end portion of the second vertically oriented conveyor tower which is provided with a service window for servicing food patrons disposed within the second vehicular traffic lane;

FIG. 6 is a perspective view of a computer-controlled door adjustment mechanism for use in conjunction with the service window disclosed within FIG. 5;

FIG. 7 is a perspective view of a first embodiment of a customer-side vertically movable conveyor carriage which is adapted to move vertically within the second vertically oriented conveyor tower of the conveyor system disclosed within FIG. 1;

FIG. 8 is a perspective view of a second embodiment of a customer-side vertically movable conveyor carriage which is adapted to move vertically within the second vertically oriented conveyor tower of the conveyor system disclosed within FIG. 1;

FIG. 9 is a perspective view of a V-belt conveyor which is utilized to convey food orders and used trays within the horizontal conveyor housing extending above the first vehicular drive-through traffic lane and between the first and second vertically oriented conveyor towers of the conveyor system as disclosed within FIG. 1;

FIG. 10 is a perspective view of the conveyor system, as disclosed within FIG. 1, showing the use of a pair of vertically spaced, two-tier, horizontally oriented V-belt roller conveyors which are disposed within the horizontally oriented conveyor, disposed atop and effectively bridging and connecting the uppermost regions of the first and second vertically oriented conveyor towers, and which are utilized to convey food orders and used trays between the pair of vertically oriented conveyor towers of the conveyor system as disclosed within FIGS. 1 and 9;

FIG. 11 is a perspective view illustrating the use of magnetic coupler mechanisms to transmit rotary drive power from roller conveyor drive motors to drive rollers of the horizontally oriented V-belt roller conveyors as disclosed within FIG. 10;

FIG. 12 is a perspective view of the structural components comprising each one of the drive rollers of the horizontally oriented V-belt roller conveyors as disclosed within FIG. 11; and

FIG. 13 is a schematic view of a human-machine interface (HMI) screen which may be utilized by restaurant personnel to control the smart or computer-controlled conveyor system when an order bypass operation is to be implemented.

### DETAILED DESCRIPTION OF THE PREFERRED EMBODIMENT

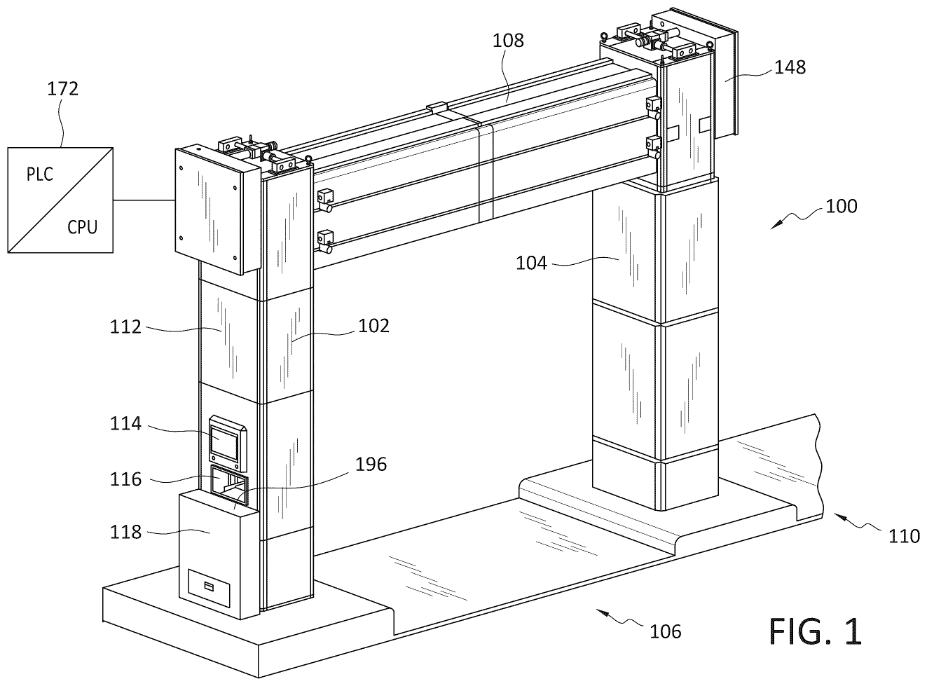

Referring now to the drawings, and more particularly to FIG. 1 thereof, the conveyor system of the present invention is disclosed and is generally indicated by reference character 100. More particularly, it is seen that the conveyor system 100 comprises a first vertically oriented conveyor tower 102, a second vertically oriented conveyor tower 104 spaced apart from the first vertically oriented conveyor tower 102 and disposed upon opposite sides of a first patron drive-through lane 106, and a horizontally oriented conveyor 108 disposed atop and effectively bridging and connecting the uppermost regions of the first and second vertically oriented conveyor towers 102,104 together so as to be disposed above the first patron-drive-through lane 106, the lower end portion of the second vertically oriented conveyor tower 104 being disposed adjacent to a second patron drive-through lane 110. It is to be noted that while the first vertically oriented conveyor tower 102 has effectively been illustrated as, or could be, a free-standing structure, more particularly, the first vertically oriented conveyor tower 102 is intended to be an integral part of the fast-food restaurant edifice and therefore comprise an external wall portion of the fast-food restaurant edifice or, even further, wholly incorporated internally within the fast-food restaurant edifice.

Once a food order has been placed and paid for, by a patron within a first vehicle, at a location upstream of the first vertically oriented conveyor tower 102, the patron within the first vehicle then drives through the first patron drive-through lane 106 and proceeds to an order pickup station in order to receive the ordered food items. In a similar manner, a second patron, disposed within a second vehicle, which will enter the second patron drive-through lane 110, will also or likewise order and pay for his/her particular food items at an upstream location, however, the second patron, disposed within the second vehicle, does not need to drive to an order pickup station, but to the contrary, the conveyor system 100 will in fact deliver the food order directly to the second patron, disposed within the second vehicle, as a result of the second patron, disposed within the second vehicle, driving into the second patron drive-through lane 110, all as will clearly be set forth hereinafter. In this manner, it can be readily appreciated that the conveyor system 100 of the present invention is significantly more efficient than current systems in that two patrons, disposed within first and second vehicles which are disposed within or pass through the first and second vehicle drive-through lanes 106, 110, can effectively be serviced simultaneously.

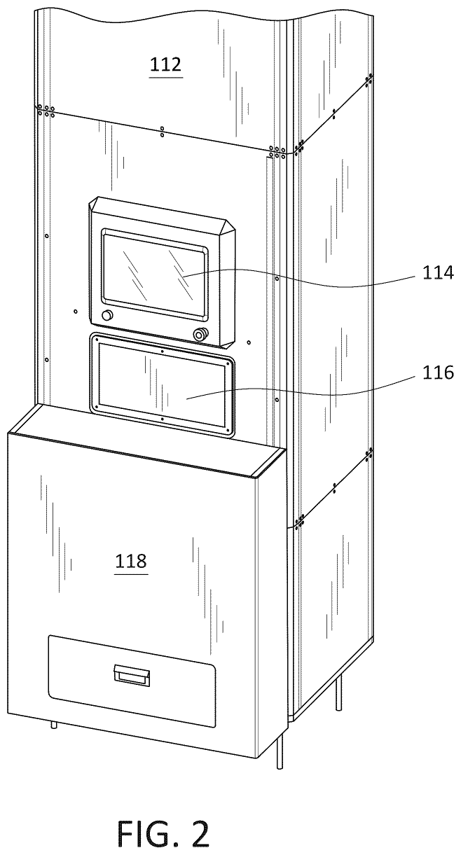

Continuing further, and with additional reference being made to FIG. 2, it is seen that the wall 112 of the first vertically oriented conveyor tower 102, that is effectively incorporated internally within the fast-food restaurant, is provided with a human-machine-interface (HMI) or touchscreen 114 which, as will be more fully disclosed hereinafter, enables restaurant personnel to initiate a conveyor actuation operation whereby a tray with a food order thereon will be moved upwardly through the first vertically oriented conveyor tower 102, through the horizontally oriented conveyor 108, and downwardly through the second vertically oriented conveyor tower 104 so as to deliver the food order to the patron disposed within the vehicle located within the second patron drive-through lane 110. The touchscreen 114 also permits restaurant personnel to track food orders, and their locations, as well as returned trays and returned food orders, and their locations, as a result of various sensors, not shown, being incorporated within the system 100, if, for example, an incorrect order was sent to a patron. Still further, restaurant personnel can utilize the touchscreen 114 to command the system 100 to return an order, before it is actually delivered to a patron, in the instance that, for example, two orders were prepared and begun to be conveyed toward the patrons, however, it was discovered that the orders were not being conveyed in the proper sequence. In addition, this same wall 112 of the first vertically oriented conveyor tower 102 also has a door or opening 116 defined therein which permits restaurant personnel to insert food trays into the first vertically oriented conveyor tower 102, and a used-tray collection box 118 which is to be used to collect used trays returned by patrons disposed within the vehicle located within the second patron drive-through lane 110 after the patrons have removed their food orders from the food trays.

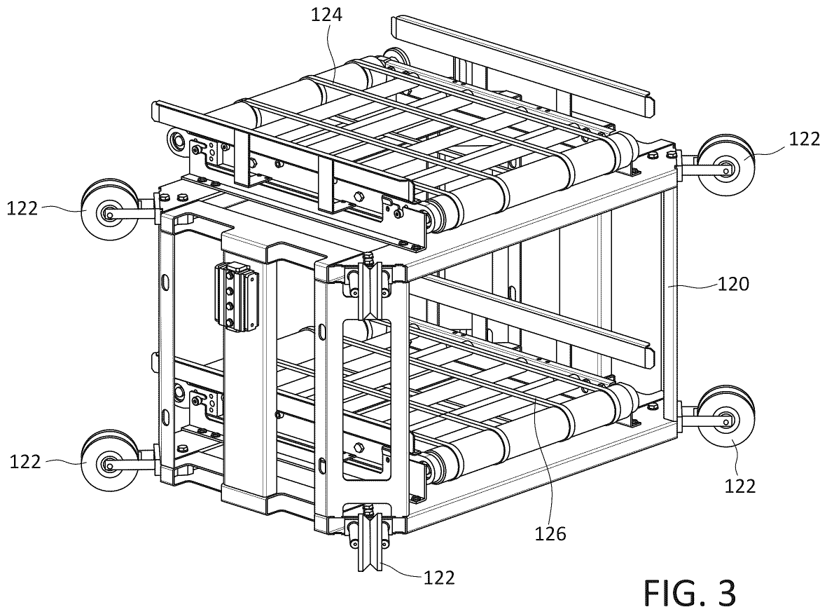

With reference now being made to FIG. 3, it is seen that a restaurant-side vertically movable conveyor carriage 120 is disclosed, and this restaurant-side vertically movable conveyor carriage 120 is adapted to move vertically within the first vertically oriented conveyor tower 102 so as to effectively traverse the vertical extent of the first vertically oriented conveyor tower 102 from a lower end region thereof to an upper end region thereof. More particularly, it is seen that the restaurant-side vertically movable conveyor carriage 120 effectively has the geometrical configuration of a hollow cube or a rectangular parallelepiped, wherein eight rollers 122 are disposed at the eight upper, lower, left side, right side, front, and rear corners of the conveyor carriage 120, the rollers 122 being adapted to move along four vertically oriented rails, not shown, fixedly secured internally within the first vertically oriented conveyor tower 102. Still further, it is seen that the conveyor carriage 120 also comprises a first upper V-belt conveyor 124, and a second lower V-belt conveyor 126 which is vertically spaced below the first upper V-belt conveyor 124 such that an open space is defined between the first upper V-belt conveyor 124 and the second lower V-belt conveyor 126 whereby a food tray, with a food order disposed thereon, can be placed upon the first upper V-belt conveyor 124, while a used food tray can be placed upon the second lower V-belt conveyor 126, as will be described more fully hereinafter. Alternatively, in the case of an unusually large food order, requiring some of the food items to be disposed upon a separate food tray, the food trays, carrying the entire, unusually large food order, can be placed upon both the upper and lower V-belt conveyors 124,126. In this instance, it will be appreciated that when the food order, disposed upon the two separate food trays, is to be transferred from the restaurant-side vertically movable conveyor carriage 120 to the horizontally oriented conveyor 108 disposed atop and effectively bridging and connecting the uppermost regions of the first and second vertically oriented conveyor towers 102,104 together, the first, upper V-belt conveyor 124 and the second lower V-belt conveyor 126 will be sequentially aligned vertically or elevationally with respect to the horizontally oriented conveyor 108. In this manner, two separate trips or movements for the restaurant-side vertically movable conveyor carriage 120 are effectively avoided in connection with the conveyance of the large food order from the restaurant-side vertically movable conveyor carriage 120 to the horizontally oriented conveyor 108, thereby rendering the conveyance procedures, in connection with the fulfillment of large food orders, more efficient.

Still further, it is also noted that there will be certain instances when a second patron, disposed within a second vehicle located within the second patron drive-through lane 110, is attempting to return a used tray, however, the tray is not in fact empty in that, for example, a food or beverage item remains upon the tray, and wherein the food or beverage item, such as, for example, a beverage container, has a height dimension which extends more than a predetermined amount above the lip of the food tray. In the instance that the item is a beverage item, this may present an undesirable situation in that if this used food tray, with the beverage container disposed thereon, was returned to the discard bin or used-tray collection box 118, the contents of the beverage container may cause a mess within the discard bin or used-tray collection box 118. Accordingly, a suitable sensor, not shown, is provided within the delivery window of the second vertically oriented conveyor tower 104, which will be described more fully hereinafter, so as to detect such protruding items whereupon, if so detected, the used, but not empty, food tray will be returned to the door or opening 116 of the first vertically oriented conveyor tower 102 such that restaurant personnel can handle such used, but not empty, food tray which, once the beverage container is removed from the used, but not empty, food tray, can then be placed within the discard bin or used-tray collection box 118.

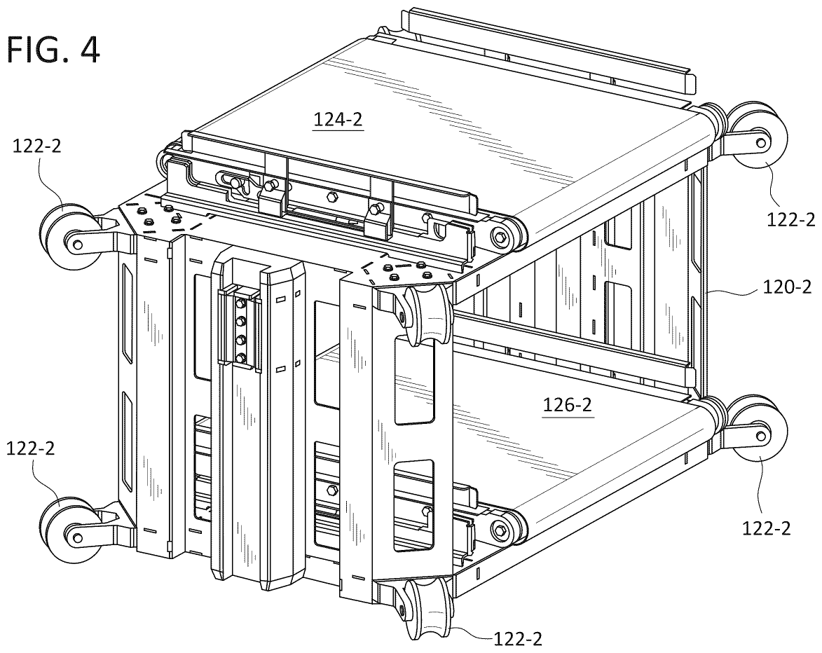

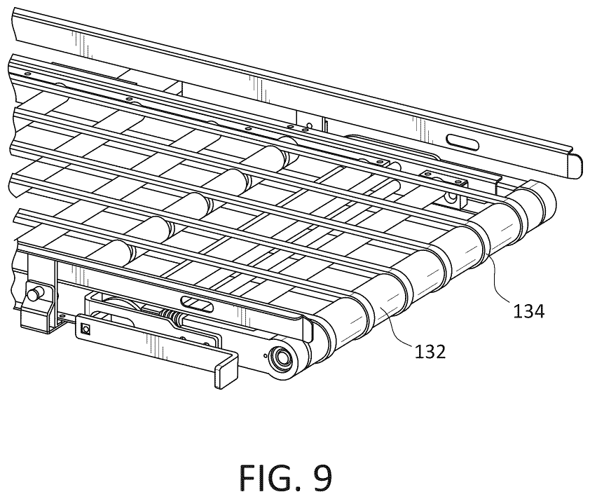

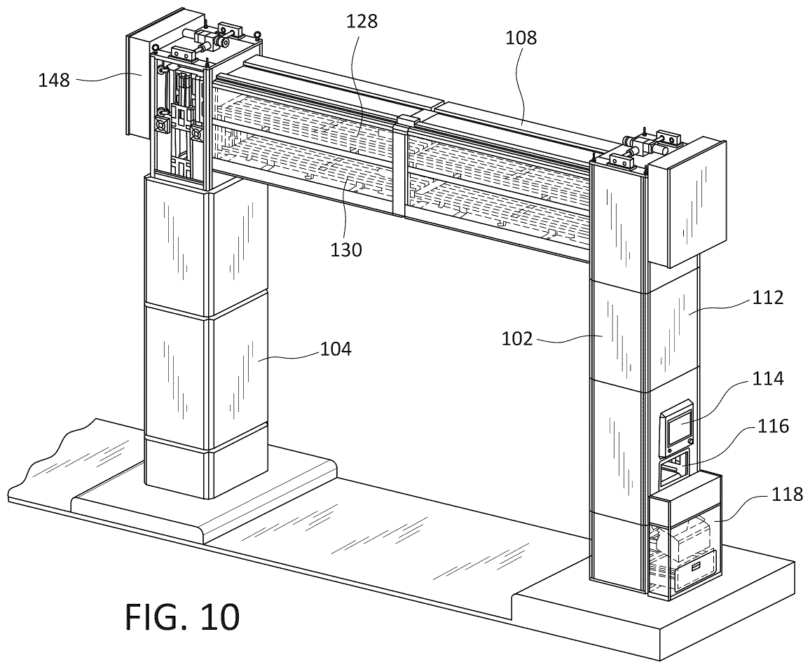

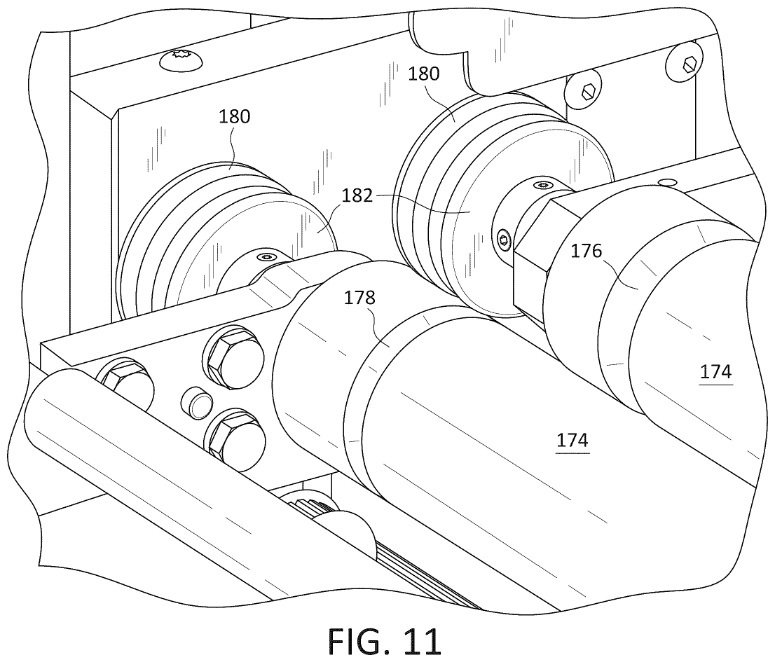

As can best be appreciated from FIG. 10, the horizontally oriented conveyor section 108 actually comprises a pair of vertically spaced, upper and lower horizontally oriented V-belt conveyors 128,130 wherein each one of the upper and lower horizontally oriented V-belt conveyors 128,130 comprises a series of V-belt conveyors whereby new orders are conveyed toward patrons, disposed within the vehicles located within the second patron drive-through lane 110, by means of the upper conveyors 128, while used food trays or returned orders are conveyed back toward the restaurant, from patrons disposed within the vehicles located within the second patron drive-through lane 110, by means of the lower conveyors 130. Each one of the V-belt conveyors 124,126,128,130 may comprise grooved rollers 132 within which endless elastomer strands or belts 134 are disposed, all as can best be appreciated from FIG. 9. Lastly, as disclosed within FIG. 4, in lieu of the upper and lower V-belt conveyors 124,126, utilized within the restaurant-side vertically movable conveyor carriage 120, the upper and lower conveyors may comprise endless belt conveyors 124-2,126-2.

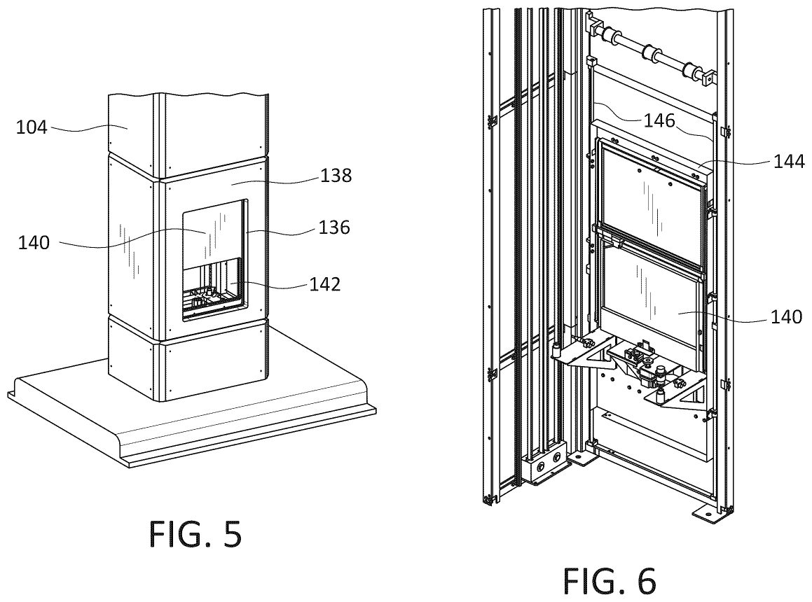

Continuing further, and with reference being made to FIGS. 5 and 6, a window 136 is fixedly defined the wall 138 of the second vertically oriented conveyor tower 104 that faces the patron vehicle disposed within the second patron drive-through lane 110, and a door 140 is vertically movable internally within the second vertically oriented conveyor tower 104 that faces the patron vehicle disposed within the second patron drive-through lane 110 so as to effectively uncover an opening or service window 142, all of which can best be appreciated from FIG. 5. As can be readily appreciated from FIG. 6, a window-adjustment carriage assembly 144 is disposed internally within the lower region of the second vertically oriented conveyor tower 104, wherein the window-adjustment carriage assembly 144 has the opening or service window 142 defined therein or thereon, and wherein the door 140 is movably disposed upon the carriage assembly 144 so as to uncover the opening or service window 142. The carriage assembly 144 is adapted to move along two, oppositely disposed, vertically oriented rails 146 which are fixedly secured internally within the second vertically oriented conveyor tower 104, and is programmed to only move vertically upwardly or downwardly along the rails 146 within predetermined limits so as to correspondingly move the opening or service window 142 to predetermined elevational levels and to correspondingly move the door 140 to different predetermined elevational levels so as to permit the opening or service window 142 to be uncovered or exposed and accessible by a patron sitting within the patron vehicle disposed within the second patron drive-through lane 110, the carriage assembly 144 being under the control of a suitable motor drive, not shown.

As is schematically illustrated within FIG. 1, the upper end region of the second vertically oriented conveyor tower 104 is provided with a radar unit, or other similar sensor 148, which can effectively detect the height of the particular vehicle disposed within the second patron drive-through lane 110. As is well-known, different vehicles have different heights, such as, for example, a two-seat roadster is quite different in height from a five-passenger sedan, and, in turn, a five-passenger sedan is quite different in height from a sport utility vehicle (SUV). Therefore, it can be readily appreciated that the driver-side windows of these various vehicles will be located at different elevations or heights relative to the window 136 fixedly defined the wall 138 of the second vertically oriented conveyor tower 104 that faces the patron vehicle disposed within the second patron drive-through lane 110. The radar unit or other similar sensor 148 is operatively connected to, or is in communication with, the drive system for the window-adjustment carriage assembly 144 such that the window-adjustment carriage assembly 144 can move the opening or service window 142 to a predetermined elevational level which will correspond to the predetermined elevational level at which the driver-side window of the particular vehicle disposed within the second patron drive-through lane 110 is located. It is to be correspondingly appreciated that the door 140 will then be moved to its OPEN position so as to in fact uncover the opening or service window 142 defined within the window-adjustment carriage assembly 144. In this manner, the food tray, containing the food order, will be located at a proper elevational level with respect to the driver-side window of the particular vehicle disposed within the second patron drive-through lane 110 whereby the patron, sitting within the particular vehicle disposed within the second patron drive-through lane 110, can easily and comfortably access the food tray which will be moved outwardly from the opening or service window 142, toward the vehicle, as will now be described.

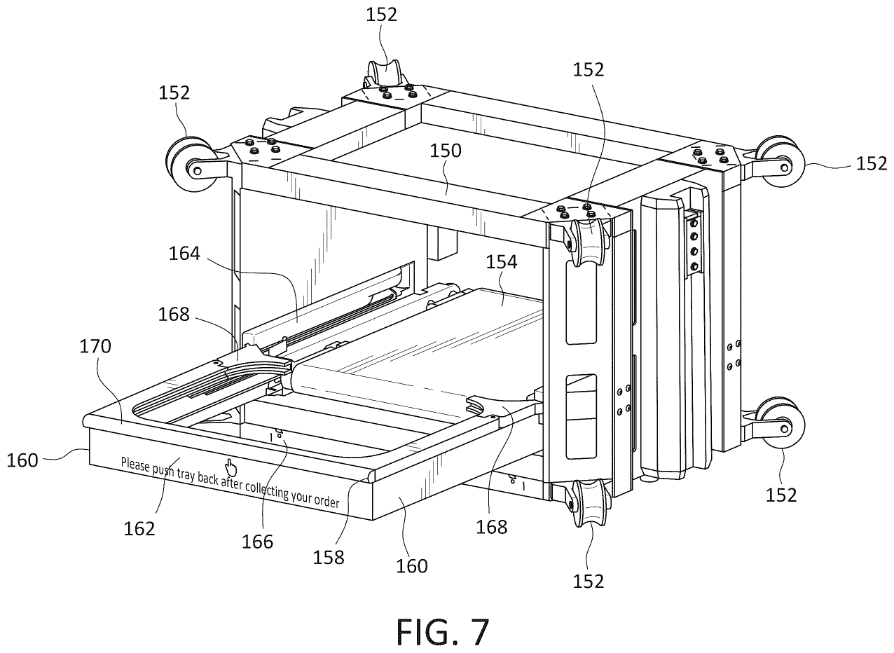

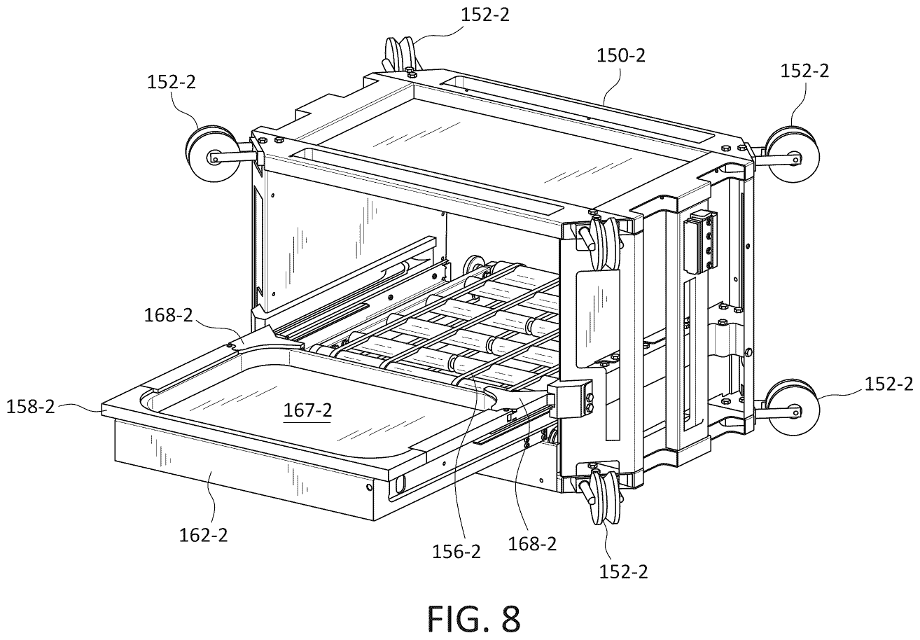

With reference therefore being made to FIG. 7, a customer-side vertically movable conveyor carriage 150 is disclosed, and this customer-side vertically movable conveyor carriage 150 is adapted to move vertically within the second vertically oriented conveyor tower 104 so as to effectively traverse the vertical extent of the second vertically oriented conveyor tower 104 from an upper end region thereof to a lower end region thereof. It is to be noted that the vertical movement of the customer-side vertically movable conveyor carriage 150 is separate and independent of the vertical movement of the window-adjustment carriage assembly 144, however, they are adapted to be operationally connected, as will be more fully explained hereinafter. More particularly, it is seen that the customer-side vertically movable conveyor carriage 150 is similar to the restaurant-side vertically movable conveyor carriage 120, as illustrated within FIG. 3, in that it likewise effectively has the geometrical configuration of a hollow cube or a rectangular parallelepiped, wherein eight rollers 152 are disposed at the eight upper, lower, left side, right side, front, and rear corners of the conveyor carriage 150, the rollers 152 being adapted to move along four vertically oriented rails, not shown, fixedly secured internally within the second vertically oriented conveyor tower 104. Unlike the restaurant-side, vertically movable carriage 120, however, it is seen that the customer-side, vertically movable conveyor carriage 150 comprises only a single, endless belt conveyor 154, or a plurality of endless V-belt conveyors 156-2, as illustrated within FIG. 8, and a food-tray-support framework 158,158-2 which is adapted to be moved between extended and retracted positions, with respect to the single, endless belt conveyor 154, or V-belt conveyors 156-2, by means of a suitable motor-drive, not shown. The food-tray-support framework 158 is seen to essentially comprise a three-sided framework comprising a pair of oppositely disposed side portions 160,160, and a forward end portion 162, wherein the two oppositely disposed side portions 160,160 are adapted to be moved along the oppositely sides of the single, endless conveyor 154, and along tracks or rails 164 when the food-tray-support framework 158 is being moved between its extended and retracted positions. When the food-tray-support framework 158 is disposed at its retracted position, the three-sided framework 158 effectively defines a three-sided pocket 166 into which a food tray 167-2, as disclosed within FIG. 8, having a food order disposed thereon, has been conveyed by means of the endless conveyor 154, 156-2.

It is further noted that rear end corner portions 168,168, 168-2, 168-2 of the food-tray-support framework 158, 158-2 are hingedly connected to rear end portions of the two oppositely disposed side portions 160, 160, 160-2,160-2 of the food-tray-support framework 158, 158-2 such that when the food-tray-support framework 158, 158-2 is disposed at its retracted position, and begins to move toward its extended position, the rear end corner portions 168,168,168-2,168-2 will be pivoted inwardly to their respective positions, by means of a suitable motor drive, not shown, as illustrated within FIGS. 7 and 8, such that the food tray 167-2, having the food order disposed thereon, will effectively be securely entrapped within the food-tray-support framework 158,158-2 as a result of the hinged corner portions 168,168, 168-2,168-2 engaging the rear corner portions of the food tray 167-2. To the contrary, when the food-tray-support framework 158,158-2 is disposed at its extended position and is being moved toward its retracted position, the hingedly connected rear end corner portions 168,168,168-2,168-2 of the food-tray-support framework 158,158-2 will be pivoted outwardly so as to be accommodated within the pair of oppositely disposed tracks or rails 164 and thereby permit the internal wall section of the forward end portion or cross-bar 162 of the food-tray-support framework 158 to effectively abut or be disposed immediately adjacent to the forward or leading end portion of the single, endless conveyor 154,156-2 whereby when the food-tray-support framework 158,158-2 is retracted, the food tray 167-2, having the food order disposed thereon, can be easily conveyed onto the single, endless conveyor 154, 156-2. As will also be discussed more fully hereinafter, it is noted that when the food-tray-support framework 158,158-2 is being extended or retracted, the endless conveyors 154,156-2 are not actuated or powered.

It is lastly noted that the forward end portion of the food-tray-support framework 158 is also provided with a suitable sensor, such as, for example, an ultrasonic sensor, not shown, which, when the food-tray-support framework 158 is moved forwardly or extended toward the vehicle disposed within the second patron drive-through lane 110, the food-tray-support framework 158 will always be extended a predetermined distance so as not to bump into or engage the vehicle. If, however, it is detected that the vehicle is effectively too close to the second vertically oriented conveyor tower 104, the ultrasonic sensor, not shown, will control/stop the suitable motor-drive, also not shown, such that the food-tray support framework 158 will not bump or engage the vehicle. That being said, in case the food-tray-support framework 158 does in fact engage the vehicle, the forward end portion of the food-tray-support framework 158 is also provided with a suitable bumper 170. Lastly, after the patron disposed within the vehicle disposed within the second patron drive-through lane 110 has retrieved their food order from the food tray disposed within the food-tray-support framework 158, then when the vehicle disposed within the second patron drive-through lane drives away, the radar unit or other similar sensor 148 will effectively sense the absence of the vehicle and will activate the motor drive, not shown, whereby the food-tray-support framework 158,158-2 will be retracted back into the customer-side, vertically movable conveyor carriage 150. It is to be noted that various different motor drives or actuators, not shown, may be utilized to drive the various conveyors and carriages, and that all movements or operations of such motor drives, actuators, conveyors, and carriages will be under the automatic control of a suitable central processing unit (CPU) or programmable logic controller (PLC) 172 as schematically illustrated within FIG. 1. Lastly, for those restaurants that do not incorporate a radar sensor system 148 into their overall conveyor system 100, the patron, within the vehicle disposed within the second patron drive-through lane 110, can impart a pushing force onto the forward end portion or cross-bar 162,162-2 of the food-tray-support framework 158,158-2 whereby the food-tray-support framework 158,158-2 will be automatically retracted back into the customer-side, vertically movable conveyor carriage 150.

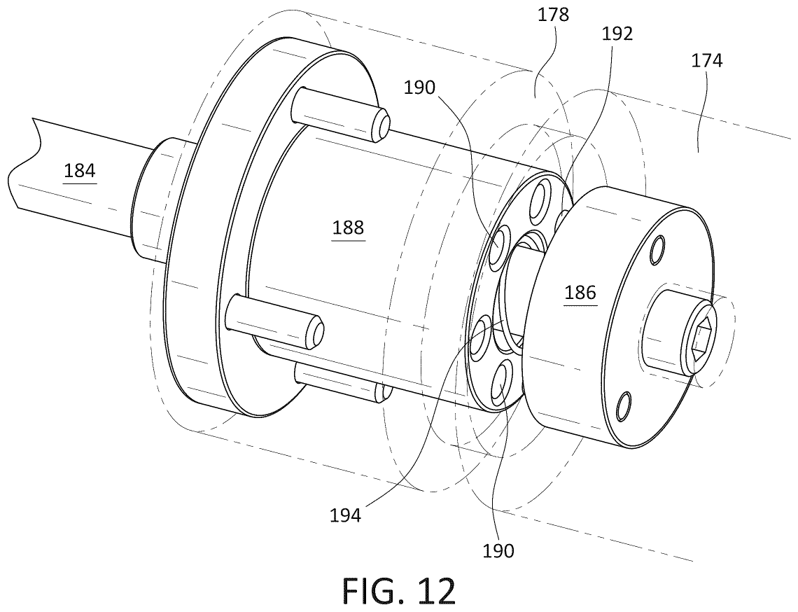

With reference now being made to FIGS. 11 and 12, it is to be noted further that the drive for the various belt conveyors, such as, for example, the series of V-belt conveyors 128,130, as disclosed within FIG. 10, may comprise a combined magnetic coupler/mechanical drive system.

More particularly, each one of the V-belt conveyors 128,130, comprising the plurality of V-belt conveyors 128,130, comprises a drive roller 174 and a plurality of endless, elastomer strands or V-belts 176 disposed around the rollers 174 wherein the plurality of endless, elastomer strands or V-belts 176 are adapted to be disposed within grooves 178 circumferentially defined within outer surface portions of the drive rollers 174 as well as within outer surface portions of the driven rollers comprising each one of the V-belt conveyors 128,130. The drive system for each drive roller 174 comprises a synchronous magnetic coupler comprising a first or primary magnetic disc or rotor 180 and a second or secondary magnetic disc or rotor 182. As can best be seen or appreciated from FIG. 12, the second or secondary magnetic disc or rotor 182 is operatively connected to a shaft 184 which has a disc 186 mounted upon a distal end thereof, wherein the disc 186 is disposed internally within the drive roller 174. In addition, a cylinder 188 is likewise disposed internally within the drive roller 174 such that a distal end of the cylinder 188 is disposed adjacent to the disc 186.

As can be further appreciated from FIG. 12, the distal end face of the cylinder 188 is provided with a plurality of apertures or holes 190 which are arranged within a circular array. Correspondingly, the internal end face of the disc 186, facing the distal end face of the cylinder 188, is provided with a plurality of axially extending pins 192, also arranged within a circular array, which are adapted to be disposed within the plurality of holes or apertures 190 disposed within the distal end face of the cylinder 188. The first or primary magnetic disc or rotor 180 is adapted to be rotatably driven by means of a suitable motor drive, not shown, such that when the first or primary, and second or secondary magnetic discs or rotors 180,182 are effectively brought together with respect to each other, they will be magnetically coupled together in accordance with well-known principles of the operation of a synchronous magnetic coupler. Lastly, a coil spring 194, disposed around the shaft 184 and interposed between the cylinder 188 and the disc 186, normally biases the first or primary, and second or secondary magnetic discs or rotors 180,182 apart from each other, however, when the first or primary, and second or secondary magnetic discs or rotors 180,182 are brought together and are magnetically coupled together, the magnetic attractive or coupling force, defined between the first or primary, and second or secondary magnetic discs or rotors 180,182, will overcome the biasing force of the coil spring 194 and thereby permit the plurality of pins 192 to be engaged within their respective holes or apertures 190. In this manner, the combined structure of the magnetic coupler/mechanical drive system is achieved.

Having described all of the operational components of the new and improved conveyor system 100, a brief operational process will now be described as to how the new and improved conveyor system 100 of the present invention works. As has been noted, when a patron, disposed within a vehicle located within the first patron drive-through lane 106 orders and pays for his/her food order, the patron then drives his vehicle to a food order pickup station, not shown. However, when a patron, disposed within a vehicle located within the second patron drive-through lane 110 orders and pays for his/her food order, the food order is prepared, disposed upon a food delivery tray 167-2, and the food delivery tray 167-2 is inserted through the opening 116 defined within the wall portion 112 of the first vertically oriented conveyor tower 102. It is to be noted that at this time, the central processing unit (CPU) or programmable logic controller (PLC) 172 will control the vertical disposition of the restaurant-side vertically movable conveyor 120 to be located at such a position internally within the first vertically oriented conveyor tower 102 that the first upper endless conveyor 124 will effectively be aligned with the opening 116 defined within the wall portion 112 of the first vertically oriented conveyor tower 102 whereby the food tray 167-2, with the food order disposed thereon, will be able to be placed upon the first upper endless conveyor 124. Subsequently, the central processing unit (CPU) or the programmable logic controller (PLC) 172 will control the vertical disposition of the restaurant-side vertically movable conveyor carriage 120 such that the restaurant-side vertically movable conveyor carriage 120 will be moved vertically upwardly within the first vertically oriented conveyor tower 102 whereby the first upper endless conveyor 124 of the restaurant-side vertically movable conveyor carriage 120 will now be elevationally aligned with the first upper conveyor 128 of the pair of horizontally oriented, vertically spaced conveyors 128,130 whereby the food tray 167-2 can now effectively be transferred from the first upper endless conveyor 124 of the restaurant-side vertically movable conveyor carriage 120 onto the first upper conveyor 128 of the pair of horizontally oriented, vertically spaced conveyors 128,130.

Continuing further, the first upper conveyor 128 of the pair of horizontally oriented, vertically spaced conveyors 128,130 will then convey the food tray 167-2, with the food order disposed thereon, toward the second vertically oriented conveyor tower 104. At this time, the central processing unit (CPU) or programmable logic controller (PLC) 172 will control the vertical disposition of the customer-side vertically movable conveyor carriage 150 such that the customer-side vertically movable conveyor carriage 150 will be moved vertically upwardly within the second vertically oriented conveyor tower 104 whereby the endless conveyor 154 of the customer-side vertically movable conveyor carriage 150 will now be elevationally aligned with the first upper conveyor 128 of the pair of horizontally oriented, vertically spaced conveyors 128,130 whereby the food tray 167-2 can now effectively be transferred from the first upper conveyor 128 of the pair of horizontally oriented, vertically spaced conveyors 128,130 onto the endless conveyor 154 of the customer-side vertically movable conveyor carriage 150. Subsequently, the programmable logic controller (PLC) or central processing unit (CPU) 172 will control the vertical disposition of the customer-side vertically movable conveyor carriage 150 such that the customer-side vertically movable conveyor carriage 150 will be moved vertically downwardly within the second vertically oriented conveyor tower 104 whereby the endless conveyor 154 of the customer-side vertically movable conveyor carriage 150 will engage and interlock with the window-adjustment carriage 144 to a predetermined vertical elevation within the second vertically oriented conveyor tower 104 in accordance with suitable signals generated by means of the radar unit 148 such that the endless conveyor 154 of the customer-side vertically movable conveyor carriage 150 will now be disposed at a predetermined vertical disposition corresponding to the opening or service window 142 through means of which the food-tray-support framework 158 can be extended so as to enable the patron, located within the vehicle located within the second patron drive-through lane 110, to retrieve his/her food order from the food tray 167-2 disposed within the food-tray-support framework 158.

After the patron, disposed within the vehicle which is disposed within the second patron drive-through lane 110, has retrieved their food order from the food tray disposed within the food-tray-support framework 158, then when the vehicle disposed within the second patron drive-through lane drives away, the radar unit or other similar sensor 148 will effectively sense the absence of the vehicle and will activate the motor drive, not shown, whereby the food-tray-support framework 158,158-2 will be retracted back into the customer-side, vertically movable conveyor carriage 150 such that the food tray can be returned to the restaurant as a result of the food tray being conveyed upwardly upon the customer-side vertically movable conveyor carriage 150 within the second vertically oriented conveyor tower 104, transferred onto the second lower conveyor 130 of the pair of horizontally oriented, vertically spaced conveyors 128,130, subsequently transferred from the second lower conveyor 130 of the pair of horizontally oriented, vertically spaced conveyors 128,130 onto the second lower endless conveyor 126 of the restaurant-side vertically movable conveyor carriage 120, and then moved downwardly by means of the restaurant-side vertically movable conveyor carriage 120. More particularly, the second lower endless conveyor 126 will be vertically aligned with a discharge chute, not shown, which is in communication with the upper open end of the used-tray collection box 118, such that the used tray 167-2 can be deposited into the used-tray collection box 118. It is noted that the window adjustment carriage 144 is spring-biased upwardly so as to normally be disposed at an uppermost position at which the customer-side vertically movable conveyor carriage 150 can readily engage and interlock with the window-adjustment carriage 144. It is lastly noted that all of the carriage and conveyor components are moved at a predetermined speed, acceleration, deceleration, and with relative coordination with respect to each other, as controlled by means of the central processing unit (CPU) or programmable logic controller (PLC) 172, such that no components of the food orders will tend to slip, slide, or spill during their conveyance along the various conveyor paths. In particular, the differential between the different conveyors can be zero such that a smooth, continuous, conveyance of the food orders proceeds without any undesirable mishaps.

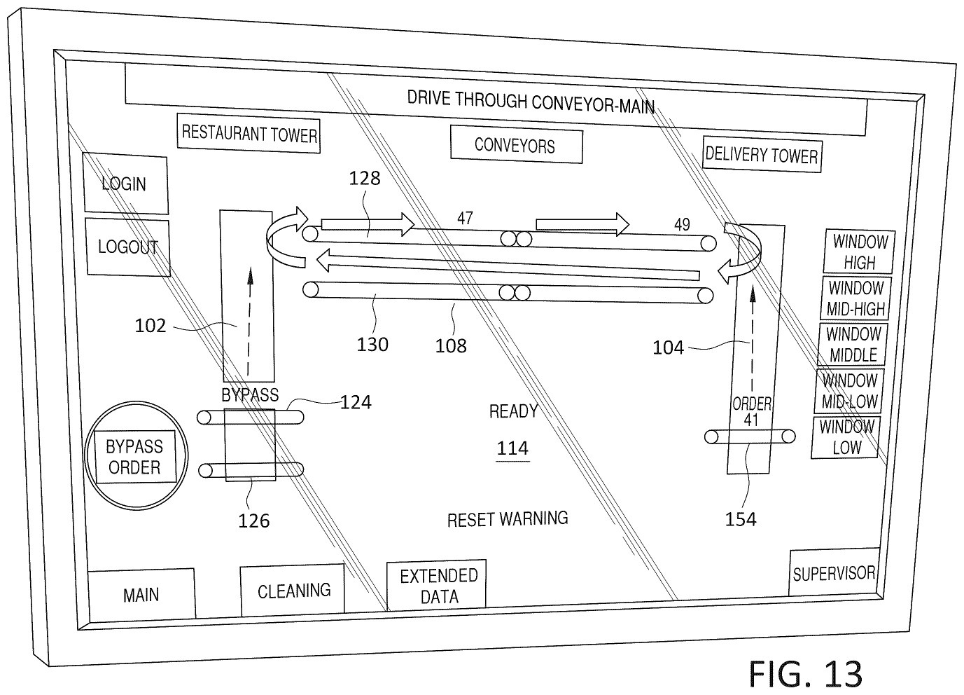

With reference lastly being made to FIG. 13, there is disclosed an additional significantly unique bypass system of the present inventive conveyor system 100 whereby, if an error occurs within an order, such as, for example, a food order is missing a particularly ordered food item, or the food order contains a wrong food item, the present inventive conveyor system 100 can quickly and easily rectify such a problem. More particularly, it is to be recalled that the human-machine-interface (HMI) or touchscreen 114 can be utilized to not only initiate a conveyor actuation operation whereby a tray with a food order thereon will be moved upwardly through the first vertically oriented conveyor tower 102, through the horizontally oriented conveyor 108, and downwardly through the second vertically oriented conveyor tower 104 so as to deliver the food order to the patron disposed within the vehicle located within the second patron drive-through lane 110, but in addition, the human-machine-interface (HMI) or touchscreen 114 can also permit restaurant personnel to track food orders, and their locations, as well as returned trays and returned food orders, and their locations, as a result of various optical sensors, not shown, but comprising, for example, various transceivers and/or video cameras, being incorporated within the system 100 along the extents of the first and second vertically oriented conveyor towers 102,104, as well as along the extent of the horizontally oriented conveyor 108, if, for example, an incorrect order was sent to a patron. As can be seen in FIG. 13, the human-machine-interface (HMI) or touchscreen 114 is disclosed and schematically displays a diagram of the conveyor system 100, including the first and second vertically oriented conveyor towers 102,104, as well as the horizontally oriented conveyor 108, which includes the upper and lower conveyors 128,130. In addition, three food orders 41,47,49 are schematically disclosed as being conveyed toward the second vertically oriented conveyor tower 104, and downwardly within the second vertically oriented conveyor tower 104, by means of the upper conveyors 128 of the horizontally oriented conveyor 108 and the customer-side vertically movable conveyor carriage 150 disposed within the second vertically oriented conveyor tower 104.

Accordingly, assuming that there is a problem with a particular food order, such as, for example, an ordered food item was not included in the delivered food order, or a particular delivered food item was an improper food item, then the second patron, sitting within the second vehicle located within the second patron drive-through lane 110, will want to return the delivered food order for the proper food order that the second patron actually ordered. Accordingly, the second patron will contact the restaurant by means of the intercom system adjacent to the second patron drive-through lane 110, whereupon restaurant personnel can initiate a return-order operation. More particularly, in accordance with this food-return-order operation, the programmable logic controller (PLC) or central processing unit (CPU) 172 will be controlled so as to, in turn, control the vertical disposition of the customer-side vertically movable conveyor carriage 150 such that the customer-side vertically movable conveyor carriage 150 will be moved vertically downwardly within the second vertically oriented conveyor tower 104 whereby the second patron, sitting within the second vehicle located within the second patron drive-through lane 110, can deposit the improper food order onto the single, endless belt conveyor 154 of the customer-side vertically movable conveyor carriage 150. The extendable tray framework 158,158-2 will be extended at this time when the second patron, sitting within the second vehicle located within the second patron drive-through lane 110, contacts restaurant personnel to initiate a food order return. After the second patron then places the incorrect food items onto the tray 167-2, restaurant personnel can retract the tray framework 158,158-2 through means of the human-machine-interface (HMI) or touchscreen 114. The customer-side vertically movable conveyor carriage 150 will then be moved upwardly within the second vertically oriented conveyor tower 104 until the single, endless belt conveyor 154 is elevationally aligned with the lower conveyor 130 of the horizontally oriented conveyor 108 whereby the returned-food-order, schematically illustrated as order 41, can be conveyed by the lower conveyor 130 of the horizontally oriented conveyor 108 back toward the first vertically oriented conveyor tower 102 whereby the returned-food-order 41 can, in turn, be transferred from the lower conveyor 130 of the horizontally oriented conveyor 108 onto the lower conveyor 126 of the restaurant-side vertically movable conveyor carriage 120 disposed within the first vertically oriented conveyor tower 102.

Once the returned-food-order has been returned, the new, correct food order may be placed upon the upper conveyor 124 of the restaurant-side vertically movable conveyor carriage 120, whereupon the restaurant-side vertically movable conveyor carriage 120 can be moved upwardly within the first vertically oriented conveyor tower 102 until the upper conveyor 124 of the restaurant-side vertically movable conveyor carriage 120 is elevationally aligned with the upper conveyor 128 of the horizontally oriented conveyor 108 whereby the correct food order can now be transferred from the upper conveyor 124 of the restaurant-side vertically movable conveyor carriage 120 to the upper conveyor 128 of the horizontally oriented conveyor 108. It is to be noted further that if other food orders, such as, for example, food orders 47,49, are disposed upon the upper conveyor 128 of the horizontally oriented conveyor 108 and are ahead of the new, correct food order to be conveyed to the second patron, sitting within the second vehicle located within the second patron drive-through lane 110, as considered in the direction of conveyance along the upper conveyor 128 of the horizontally oriented conveyor 108, then the customer-side vertically movable conveyor carriage 150 can be moved vertically, upwardly and downwardly within the second vertically oriented conveyor tower 104 so as to permit the food orders 47,49 to be transferred onto the conveyor 154 of the customer-side vertically movable conveyor carriage 150 and then, in turn, transferred onto the lower conveyor 130 of the horizontally oriented conveyor 108.

Subsequently, the correct food order will have been moved to the customer-side/end of the upper conveyor 128 of the horizontally oriented conveyor 108 whereby it can be transferred to the conveyor 154 of the customer-side vertically movable conveyor carriage 150, whereby the customer-side vertically movable conveyor carriage 150 can then move downwardly within the second vertically oriented conveyor tower 104 so as to be delivered to the second patron sitting within the second vehicle located within the second patron drive-through lane 110. It is to be lastly noted that since the entire system 100 is under the control of the programmable logic controller (PLC) or central processing unit (CPU) 172, it is to be understood that the various returned food trays may be conveyed back toward the restaurant while the replacement order(s) is(are) being conveyed toward the patron disposed within the vehicle disposed within the second patron drive-through lane 110. In other words, it is not necessary for an original order to be returned from the patron disposed within the vehicle disposed within the second patron drive-through lane 110 before the replacement order can be conveyed toward the patron disposed within the vehicle disposed within the second patron drive-through lane 110 in view of the fact that the central processing unit (CPU) or programmable logic controller (PLC) 172 can control the return and replacement orders in a precisely organized and timely manner. This asynchronous operation of the various tower and horizontal conveyors is one of the key features and attributes of the present invention.

Obviously, many variations and modifications of the present invention are possible in light of the above teachings. For example, it is noted that an additional feature of the present invention resides in the fact that the sensor activated-computer-controlled system can control the upper and lower conveyors of the first conveyor carriage vertically movable within the first vertically oriented conveyor tower, and the upper and lower conveyors of the horizontally oriented conveyor disposed within the horizontally oriented conveyor housing, such that one of the upper and lower conveyors of the first conveyor carriage vertically movable within the first vertically oriented conveyor tower, and one of the upper and lower conveyors of the horizontally oriented conveyor disposed within the horizontally oriented conveyor housing, can be disabled, rendered inoperative, or the like, while the other one of the upper and lower conveyors of the first conveyor carriage vertically movable within the first vertically oriented conveyor tower, and the other one of the upper and lower conveyors of the horizontally oriented conveyor disposed within the horizontally oriented conveyor housing can remain operative should one of the upper and lower conveyors of the first conveyor carriage vertically movable within the first vertically oriented conveyor tower, and one of the upper and lower conveyors of the horizontally oriented conveyor disposed within the horizontally oriented conveyor housing, become inoperative.

Another possible feature of the present invention resides in the fact that there is a unique ventilation system operatively connected to the top of each one of the vertically oriented conveyor towers. More particularly, a plurality of intake fans are disposed near the top of each tower so as to discharge climate-controlled air downwardly through a plurality of built-in ducts disposed upon inner portions of each tower. These ducts are effectively built into corner regions of each tower so as not to interfere with the movements of the conveyor carriages, whereby the climate-controlled air will be expelled near the bottom of each tower. The reason for providing such ductwork, and the climate-controlled air conveyed therethrough, is to deal with extreme cold situations by venting hot air in. The hot air will rise and circulate the inside of the tower to keep the food items at an appropriate temperature. Similar ventilation can also of course be provided within the horizontally oriented conveyor housing.

A last possible feature of the present invention has to do with the door operatively associated with the service window. More particularly, various sensors and timers can be utilized in conjunction with the door operatively associated with the service window so as to ensure that the door operates in a safe manner with respect to the patrons. For example, the door will only be moved to its closed position once the second vehicle, located within the second patron drive-through lane, has driven away, that is, after the second vehicle has been detected as having driven away, a timer will initiate the closing of the door after a predetermined period of time has elapsed. The exception to this mode of operation is when an incorrect order is being returned. In such an instance, the door will be closed first, an appropriate sensor will confirm the closure of the door, and then the conveyor carriage, disposed within the second vertically oriented conveyor tower, will be moved vertically upwardly within the second vertically oriented conveyor tower. Still further, additional sensors can also be utilized to detect if an obstruction is preventing the door from being moved to its completely closed position. It is therefore to be understood that within the scope of the appended claims, the present invention may be practiced otherwise than as specifically described herein.

What is claimed as new and desired to be protected by Letters Patent, is:

1. A smart conveyor system for conveying food orders from a restaurant to patrons disposed within vehicles, comprising:
a first patron drive-through lane, operatively associated with the restaurant, for permitting a first patron to drive therethrough;
a second patron drive-through lane, spaced apart from said first patron drive-through lane, for permitting a second patron to drive therethrough;
a first vertically oriented conveyor tower operatively associated with said first patron drive-through lane;
a second vertically oriented conveyor tower operatively associated with said second patron drive-through lane and located a predetermined distance from the restaurant;
a horizontally oriented conveyor housing extending above said first patron drive-through lane and connecting said first and second vertically oriented conveyor towers together;
at least one conveyor, disposed within each one of said first vertically oriented conveyor tower, said second vertically oriented conveyor tower, and said horizontally oriented conveyor housing, adapted to traverse said first and second vertically oriented conveyor towers, and said horizontally oriented conveyor housing, for transferring a food order from said first vertically oriented conveyor tower to said horizontally oriented conveyor housing, and from said horizontally oriented conveyor housing to said second vertically oriented conveyor tower; and
a sensor activated-computer-controlled system for detecting a vehicle within said second patron drive-through lane and for controlling said conveyor movably disposed within said second vertically oriented conveyor tower such that the vertical disposition of said conveyor, disposed within said second vertically oriented conveyor tower, can be properly positioned with respect to the vehicle disposed within said second patron drive-through lane such that a driver/patron within the vehicle, disposed within said second patron drive-through lane, can easily access the food order delivered by said conveyor movably disposed within said second vertically oriented conveyor tower.

2. The smart conveyor system as set forth in claim 1, wherein said at least one conveyor, disposed within each one of said first vertically oriented conveyor tower, said second vertically oriented conveyor tower, and said horizontally oriented conveyor housing, and adapted to traverse said first and second vertically oriented conveyor towers and said horizontally oriented conveyor housing, comprises:
a first conveyor carriage vertically movable within said first vertically oriented conveyor tower;
a horizontally oriented conveyor disposed within said horizontally oriented conveyor housing; and
a second conveyor carriage vertically movable within said second vertically oriented conveyor tower.

3. The smart conveyor system as set forth in claim 2, wherein:
said horizontally oriented conveyor disposed within said horizontally oriented conveyor housing comprises a first upper horizontally movable conveyor for conveying a food order from said first vertically oriented conveyor tower and toward said second vertically oriented conveyor tower for delivery to the second patron, and a second lower horizontally movable conveyor for conveying used food trays from said second vertically oriented conveyor tower and toward said first vertically oriented conveyor tower so as to return used food trays to the restaurant.

4. The smart conveyor system as set forth in claim 2, wherein:
said computer-controlled system comprises a controller selected from the group comprising a programmable logic controller (PLC) and a central processing unit (CPU) for controlling the movements of said plurality of conveyors.

5. The smart conveyor system as set forth in claim 2, wherein:
said horizontally oriented conveyor disposed within said horizontally oriented conveyor housing, comprising said first upper horizontally movable conveyor for conveying a food order from said first vertically oriented conveyor tower and toward said second vertically oriented conveyor tower for delivery to the second patron, and said second lower horizontally movable conveyor for conveying used food trays from said second vertically oriented conveyor tower and toward said first vertically oriented conveyor tower, along with said first conveyor carriage vertically movable within said first vertically oriented conveyor tower and said second conveyor carriage vertically movable within said second vertically oriented conveyor tower, comprise a food order bypass system for prioritizing quick replacement of incorrect food orders to the patron.

6. The smart conveyor system as set forth in claim 4, wherein:
said programmable logic controller (PLC) and said central processing unit (CPU), for controlling the movements of said plurality of conveyors, can control said movements of said plurality of conveyors in an asynchronous manner such that various different food delivery and return operations can be controlled simultaneously.

7. The smart conveyor system as set forth in claim 2, further comprising:
a window-adjustment carriage operatively connected to said sensor activated-computer-controlled system for moving a service window, disposed within said second vertically oriented conveyor tower, to an elevational position corresponding to a height dimension of the vehicle disposed within said second patron drive-through lane.

8. The smart conveyor system as set forth in claim 7, wherein:
said second conveyor carriage, vertically movable within said second vertically oriented conveyor tower, is operatively connected to said window-adjustment carriage.

9. The smart conveyor system as set forth in claim 2, wherein:
said second conveyor carriage, vertically movable within said second vertically oriented conveyor tower, has an extendable/retractable food-tray-support framework movably mounted thereon.

10. The smart conveyor system as set forth in claim 9, wherein:
said extendable/retractable food-tray-support-platform is extended a predetermined distance, in accordance with said sensor activated-computer-controlled system, so as not to damage the vehicle when said extendable/retractable food-tray-support-platform is extended toward the vehicle.

11. The smart conveyor system as set forth in claim 2, wherein:
said first conveyor carriage vertically movable within said first vertically oriented conveyor tower comprises upper and lower conveyors; and
said horizontally oriented conveyor disposed within said horizontally oriented conveyor housing comprises upper and lower conveyors.

12. The smart conveyor system as set forth in claim 11, wherein:
said sensor activated-computer-controlled system can control food orders disposed upon both said upper and lower conveyors of said first conveyor carriage vertically movable within said first vertically oriented conveyor tower, and upon both said upper and lower conveyors of said horizontally oriented conveyor movably disposed within said horizontally oriented conveyor housing,
whereby large/double orders can be conveyed from said restaurant to said patron disposed within the vehicle disposed within said second patron drive-through lane.

13. The smart conveyor system as set forth in claim 11, wherein:
said sensor activated-computer-controlled system can control said upper and lower conveyors of said first conveyor carriage vertically movable within said first vertically oriented conveyor tower, and said upper and lower conveyors of said horizontally oriented conveyor disposed within said horizontally oriented conveyor housing, such that one of said upper and lower conveyors of said first conveyor carriage vertically movable within said first vertically oriented conveyor tower, and one of said upper and lower conveyors of said horizontally oriented conveyor disposed within said horizontally oriented conveyor housing, can be disabled while the other one of said upper and lower conveyors of said first conveyor carriage vertically movable within said first vertically oriented conveyor tower, and the other one of said upper and lower conveyors of said horizontally oriented conveyor disposed within said horizontally oriented conveyor housing can remain operative should one of said upper and lower conveyors of said first conveyor carriage vertically movable within said first vertically oriented conveyor tower, and one of said upper and lower conveyors of said horizontally oriented conveyor disposed within said horizontally oriented conveyor housing, become inoperative.

14. The smart conveyor system as set forth in claim 1, further comprising:
a human-machine-interface for tracking food orders and returned orders being conveyed by said at least one conveyor.

15. A smart conveyor system for conveying food orders from a restaurant to patrons disposed within vehicles, comprising:
a patron drive-through lane, spaced apart from said restaurant, for permitting a patron to drive therethrough;
a first vertically oriented conveyor tower operatively associated with said restaurant;
a second vertically oriented conveyor tower operatively associated with said patron drive-through lane and located a predetermined distance from said restaurant;
a horizontally oriented conveyor housing extending between, and connecting together, upper ends of said first and second vertically oriented conveyor towers;
at least one conveyor, disposed within each one of said first vertically oriented conveyor tower, said second vertically oriented conveyor tower, and said horizontally oriented conveyor housing, adapted to traverse said first and second vertically oriented conveyor towers, and said horizontally oriented conveyor housing, for transferring a food order from said first vertically oriented conveyor tower to said horizontally oriented conveyor housing, and from said horizontally oriented conveyor housing to said second vertically oriented conveyor tower; and
a sensor activated-computer-controlled system for detecting a vehicle within said second patron drive-through lane and for controlling said conveyor movably disposed within said second vertically oriented conveyor tower such that the vertical disposition of said conveyor, disposed within said second vertically oriented conveyor tower, can be properly positioned with respect to the vehicle disposed within said patron drive-through lane such that a driver/patron within the vehicle, disposed within said patron drive-through lane, can easily access the food order delivered by said conveyor movably disposed within said second vertically oriented conveyor tower.

16. The smart conveyor system as set forth in claim 15, wherein said at least one conveyor adapted to traverse said first and second vertically oriented conveyor towers and said horizontally oriented conveyor housing, comprises:
a first conveyor carriage vertically movable within said first vertically oriented conveyor tower;
a horizontally oriented conveyor disposed within said horizontally oriented conveyor housing; and
a second conveyor carriage vertically movable within said second vertically oriented conveyor tower.

17. The smart conveyor system as set forth in claim 16, wherein
said horizontally oriented conveyor disposed within said horizontally oriented conveyor housing comprises a first upper horizontally movable conveyor for conveying a food order from said first vertically oriented conveyor tower and toward said second vertically oriented conveyor tower for delivery to the second patron, and a second lower horizontally movable conveyor for conveying used food trays from said second vertically oriented conveyor tower and toward said first vertically oriented conveyor tower so as to return used food trays to the restaurant.

18. The smart conveyor system as set forth in claim 15, wherein:
said sensor-activated computer-controlled system comprises a controller selected from the group comprising a programmable logic controller (PLC) and a central processing unit (CPU) for controlling the movements of said plurality of conveyors.

19. The smart conveyor system as set forth in claim 16, wherein:
said horizontally oriented conveyor disposed within said horizontally oriented conveyor housing, comprising said first upper horizontally movable conveyor for conveying a food order from said first vertically oriented conveyor tower and toward said second vertically oriented conveyor tower for delivery to the second patron, and said second lower horizontally movable conveyor for conveying used food trays from said second vertically oriented conveyor tower and toward said first vertically oriented conveyor tower, along with said first conveyor carriage vertically movable within said first vertically oriented conveyor tower and said second conveyor carriage vertically movable within said second vertically oriented conveyor tower, comprise a food order bypass system for returning incorrect food orders to the restaurant.

20. The smart conveyor system as set forth in claim 18, wherein:
said programmable logic controller (PLC) and said central processing unit (CPU), for controlling the movements of said plurality of conveyors, can control said movements of said plurality of conveyors in an asynchronous manner such that various different food delivery and return operations can be controlled simultaneously.

21. A smart conveyor system for conveying food orders from a restaurant to patrons disposed within vehicles, comprising:
a patron drive-through lane, spaced apart from said restaurant, for permitting a patron to drive therethrough;
a first vertically oriented conveyor tower operatively associated with said restaurant;
a second vertically oriented conveyor tower operatively associated with said patron drive-through lane and located a predetermined distance from said restaurant;
a horizontally oriented conveyor housing extending between, and connecting together, upper ends of said first and second vertically oriented conveyor towers;
at least one conveyor, disposed within each one of said first vertically oriented conveyor tower, said second vertically oriented conveyor tower, and said horizontally oriented conveyor housing, adapted to traverse said first and second vertically oriented conveyor towers, and said horizontally oriented conveyor housing, for transferring a food order from said first vertically oriented conveyor tower to said horizontally oriented conveyor housing, and from said horizontally oriented conveyor housing to said second vertically oriented conveyor tower; and
a computer control system, operatively connected to said at least one conveyor, disposed within each one of said first vertically oriented conveyor tower, said second vertically oriented conveyor tower, and said horizontally oriented conveyor housing for controlling said at least one conveyor, disposed within each one of said first vertically oriented conveyor tower, said second vertically oriented conveyor tower, and said horizontally oriented conveyor housing whereby said at least one conveyor, disposed within each one of said first vertically oriented conveyor tower, said second vertically oriented conveyor tower, and said horizontally oriented conveyor housing, are moved at a predetermined speed, acceleration, deceleration, with respect to each other, such that no components of the food orders will tend to slip, slide, or spill during their conveyance along said at least one conveyor, disposed within each one of said first vertically oriented conveyor tower, said second vertically oriented conveyor tower, and said horizontally oriented conveyor housing.
